(19) United States
(12) Patent Application Publication
(10) Pub. No.: US 2023/0154425 A1
(43) Pub. Date: May 18, 2023

(54) METHOD AND DEVICE FOR RELIEVING FRACTURE PHENOMENON OF LIQUID CRYSTAL DISPLAY PANEL, AND DISPLAY PANEL

(71) Applicant: Shenzhen China Star Optoelectronics Semiconductor Display Technology Co., Ltd., Shenzhen, Guangdong (CN)

(72) Inventors: Bo HAI, Shenzhen, Guangdong (CN); Meng WANG, Shenzhen (CN)

(73) Assignee: Shenzhen China Star Optoelectronics Semiconductor Display Technology Co., Ltd., Shenzhen, Guangdong (CN)

(21) Appl. No.: 17/046,010

(22) PCT Filed: Sep. 4, 2020
(86) PCT No.: PCT/CN2020/113440

§ 371 Date: Oct. 8, 2020

(30) Foreign Application Priority Data
Aug. 7, 2020 (CN) 202010789016.0

(51) Int. Cl. G09G 3/36

(52) U.S. Cl. CPC G09G 3/36; G09G 2360/16; G09G 2320/0233

(57) ABSTRACT

A method and device for relieving a fracture phenomenon of a liquid crystal display panel, and the liquid crystal display panel are provided. The method includes: obtaining a fracture location including two or more fracture regions; performing brightness processing on the fracture regions; determining that there is a brightness difference between the fracture regions before the brightness processing if a brightness difference between the fracture regions is reduced after the brightness processing; and reducing the brightness difference between the fracture regions if there is the brightness difference between the fracture regions.

### FIELD OF INVENTION

The present disclosure relates to the technical field of display, and particularly to a method and device for relieving a fracture phenomenon of a liquid crystal display panel, and a display panel.

### BACKGROUND

Liquid crystal display devices occupy an important position in the field of display due to their advantages of lightness, thinness, low radiation, and the like. A display screen of a liquid crystal display panel is composed of multiple pixels. Each of the pixels comprises a red sub-pixel, a green sub-pixel, and a blue sub-pixel. Brightness of the sub-pixels can be controlled by inputting brightness information of the sub-pixels, that is, RGB grayscale values. By controlling the grayscale values of the sub-pixels, a desired display color is mixed to display a color image.

However, an image fracture phenomenon sometimes occurs when liquid crystal display panels display images, which causes abnormal display of the display panels and affects visual effect to human's eyes.

### SUMMARY OF DISCLOSURE

Accordingly, the present disclosure provides a method and device for relieving a fracture phenomenon of a liquid crystal display panel, and the display panel to relieve a fracture phenomenon of display images.

In a first aspect, the present disclosure provides a method for relieving a fracture phenomenon of a liquid crystal display panel. The method comprises:

obtaining a fracture location of the display panel, wherein the fracture location comprises two or more fracture regions;

performing brightness processing on the fracture regions according to grayscale values of the fracture regions;

determining that there is a brightness difference between the fracture regions before the brightness processing if a brightness difference between the fracture regions is reduced after the brightness processing; and

adjusting the brightness of the fracture regions according to the grayscale values of the fracture regions to reduce the brightness difference between the fracture regions if there is a brightness difference between the fracture regions.

In some embodiments, after the obtaining the fracture location of the display panel, the method further comprises:

detecting grayscale values of sub-pixels in each of the fracture regions to obtain the grayscale value of each of the fracture regions.

In some embodiments, the performing the brightness processing on the fracture regions according to the grayscale values of the fracture regions comprises:

determining the brightness difference between the fracture regions according to the grayscale values of the fracture regions; and

increasing or decreasing brightness of the fracture regions according to the brightness difference between the fracture regions.

In some embodiments, the determining that there is a brightness difference between the fracture regions before the brightness processing if a brightness difference between the fracture regions is reduced after the brightness processing:

determining whether the fracture phenomenon in the fracture regions is eliminated by increasing or reducing the brightness of the fracture regions; and

judging whether the brightness difference between the fracture regions is reduced based on whether the fracture phenomenon in the fracture regions is eliminated.

In some embodiments, the adjusting the brightness of the fracture regions according to the grayscale values of the fracture regions to reduce the brightness difference between the fracture regions comprises:

reducing the brightness difference between the fracture regions according to a difference between the grayscale values of the fracture regions.

In some embodiments, after the adjusting the brightness of the fracture regions according to the grayscale values of the fracture regions to reduce the brightness difference between the fracture regions, the method further comprises:

dividing the maximum brightness difference value between two adjacent fracture regions after adjusting the brightness by the maximum brightness difference value between the two adjacent fracture regions before adjusting the brightness to obtain a ratio; and

determining that the fracture phenomenon is eliminated if the ratio is less than or equal to 50%.

In some embodiments, the brightness processing is performed by white balance processing.

In a second aspect, the present disclosure further provides a device for relieving a fracture phenomenon of a liquid crystal display panel. The device comprises:

an obtaining unit configured to obtain a fracture location of the display panel, wherein the fracture location comprises two or more fracture regions;

a processing unit configured to perform brightness processing on the fracture regions according to grayscale values of the fracture regions;

a determining unit configured to determine that there is a brightness difference between the fracture regions before the brightness processing if a brightness difference between the fracture regions is reduced after the brightness processing; and

an adjusting unit configured to adjust the brightness of the fracture regions according to the grayscale values of the fracture regions to reduce the brightness difference between the fracture regions if there is a brightness difference between the fracture regions.

In some embodiments, the device further comprises a detection unit configured to detect grayscale values of sub-pixels in each of the fracture regions to obtain the grayscale value of each of the fracture regions.

In some embodiments, the processing unit comprises:

a first determining subunit configured to determine the brightness difference between the fracture regions according to the grayscale values of the fracture regions; and

a first adjusting subunit configured to increase or decrease brightness of the fracture regions according to the brightness difference between the fracture regions.

In some embodiments, the determining unit comprises:

a second determining subunit configured to determine whether the fracture phenomenon in the fracture regions is eliminated by increasing or reducing the brightness of the fracture regions; and

a first judgment subunit configured to judge whether the brightness difference between the fracture regions is reduced based on whether the fracture phenomenon in the fracture regions is eliminated.

In some embodiments, the adjusting unit comprises:

an obtaining subunit configured to obtain a difference between the grayscale values of the fracture regions; and

a second adjusting subunit configured to reduce the brightness difference between the fracture regions according to the difference between the grayscale values of the fracture regions.

In some embodiments, the adjusting unit further comprises:

a second judgment subunit configured to divide the maximum brightness difference value between two adjacent fracture regions after adjusting the brightness by the maximum brightness difference value between the two adjacent fracture regions before adjusting the brightness to obtain a ratio, and judge whether the ratio is less than or equal to 50%; and

a third determining subunit configured to determine that the fracture phenomenon is eliminated if the ratio is less than or equal to 50%.

In a third aspect, the present disclosure further provides a liquid crystal display panel.

The liquid crystal display panel uses the aforementioned method for relieving the fracture phenomenon. The method comprises:

obtaining a fracture location of the display panel, wherein the fracture location comprises two or more fracture regions;

performing brightness processing on the fracture regions according to grayscale values of the fracture regions;

determining that there is a brightness difference between the fracture regions before the brightness processing if a brightness difference between the fracture regions is reduced after the brightness processing; and

adjusting the brightness of the fracture regions according to the grayscale values of the fracture regions to reduce the brightness difference between the fracture regions if there is a brightness difference between the fracture regions.

In some embodiments, after the obtaining the fracture location of the display panel, the method further comprises:

detecting grayscale values of sub-pixels in each of the fracture regions to obtain the grayscale value of each of the fracture regions.

In some embodiments, the performing the brightness processing on the fracture regions according to the grayscale values of the fracture regions comprises:

determining the brightness difference between the fracture regions according to the grayscale values of the fracture regions; and

increasing or decreasing brightness of the fracture regions according to the brightness difference between the fracture regions.

In some embodiments, the determining that there is a brightness difference between the fracture regions before the brightness processing if a brightness difference between the fracture regions is reduced after the brightness processing comprises:

determining whether the fracture phenomenon in the fracture regions is eliminated by increasing or reducing the brightness of the fracture regions; and

judging whether the brightness difference between the fracture regions is reduced based on whether the fracture phenomenon in the fracture regions is eliminated.

In some embodiments, the adjusting the brightness of the fracture regions according to the grayscale values of the fracture regions to reduce the brightness difference between the fracture regions comprises:

reducing the brightness difference between the fracture regions according to a difference between the grayscale values of the fracture regions.

In some embodiments, after the adjusting the brightness of the fracture regions according to the grayscale values of the fracture regions to reduce the brightness difference between the fracture regions, the method further comprises:

dividing the maximum brightness difference value between two adjacent fracture regions after adjusting the brightness by the maximum brightness difference value between the two adjacent fracture regions before adjusting the brightness to obtain a ratio; and

determining that the fracture phenomenon is eliminated if the ratio is less than or equal to 50%.

In some embodiments, the brightness processing is performed by white balance processing.

The present invention improves display brightness uniformity of a display panel, a fracture phenomenon of the liquid crystal display panel, and display quality by obtaining a fracture location of the display panel, performing brightness processing on fracture regions comprised in the fracture location according to grayscale values, determining that there is a brightness difference between the fracture regions if the fracture phenomenon is eliminated after the brightness processing, and adjusting the brightness of the fracture location to reduce the brightness difference between the fracture regions.

### BRIEF DESCRIPTION OF DRAWINGS

Specific implementation of the present disclosure will be described in detail below in conjunction with accompanying drawings to make technical solutions and beneficial effects of the present disclosure obvious.

FIG. 1 is a flowchart of a method for relieving a fracture phenomenon of a liquid crystal display panel.

FIG. 2 is a schematic diagram showing that a fracture phenomenon of a display image occurs in the display panel.

FIG. 3(a) is a graph showing normalized brightness values at every grayscale level in the display panel actually measured in front view and 45° oblique view.

FIG. 3(b) is a graph showing normalized brightness values at low grayscale level in the display panel actually measured in front view and 45° oblique view.

FIG. 4 is a block diagram of a device for relieving the fracture phenomenon of the liquid crystal display panel.

### DETAILED DESCRIPTION

Technical solutions in embodiments of the present disclosure will be clearly and completely described below in conjunction with accompanying drawings in the embodiments of the present disclosure. Apparently, the described embodiments are merely some of the embodiments of the present disclosure and not all embodiments. All other embodiments obtained by those skilled in the art based on the embodiments of the present disclosure without creative labor are within the claimed scope of the present invention.

In order to make purposes, technical solutions, and advantages of the present invention clearer, the embodiments of the present invention will be further described in detail below in conjunction with accompany drawings.

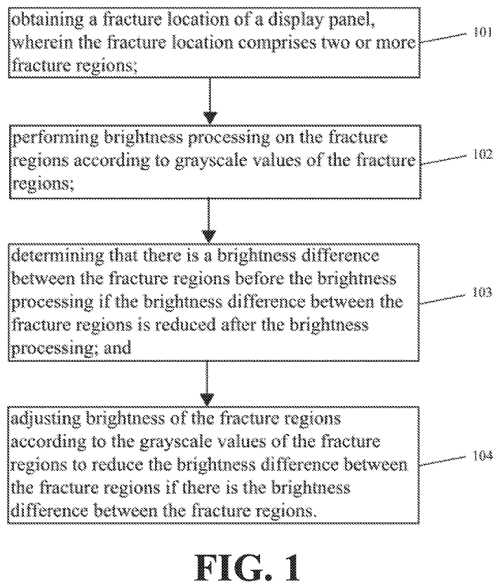

In a first aspect, the present disclosure provides a method for relieving a fracture phenomenon of a liquid crystal display panel. As shown in FIG. 1, the method comprises steps 101-104.

Step 101: obtaining a fracture location of the display panel, wherein the fracture location comprises two or more fracture regions.

The display panel comprises a plurality of pixels. Each of the pixels comprises a red sub-pixel (R), a green sub-pixel (G), and a blue sub-pixel (B). A grayscale value of the display device is n, where 0≤n≤255. 0 represents the lowest grayscale level of the display panel. 255represents the highest grayscale level of the display panel. A relationship between a grayscale value and brightness of each of the pixels of the display screen generally conforms to a gamma curve expressed by Formula (1):

L=gray^{γ} (1)

In Formula (1), L is brightness, gray is grayscale value, and γ is generally 2.2, but not limited to 2.2. The display brightness of each of the pixels of the display screen is a mixture of display brightness of its sub-pixels. When grayscale values of the red sub-pixel (R), green sub-pixel (G), and blue sub-pixel (B) are all 0, an image displayed by the display panel is black. When the grayscale values of the red sub-pixel (R), the green sub-pixel (G), and the blue sub-pixel (B) are all 255, an image displayed by the display panel is white. When driving to display a display image, the brightness of the sub-pixels is controlled by providing a grayscale value to each of the sub-pixels of the pixels, so that each of the sub-pixels displays a corresponding color. In an ideal state, the display panel correspondingly displays a display image with high brightness uniformity. However, a bright line sometimes occurs in the display image. The bright lines make the display image comprises relatively bright and relatively dark areas. This phenomenon is a fracture phenomenon.

The bright line divides the display image into the relatively bright and relatively dark areas that are defined as fracture regions. Locations of the fracture regions are defined as a fracture location.

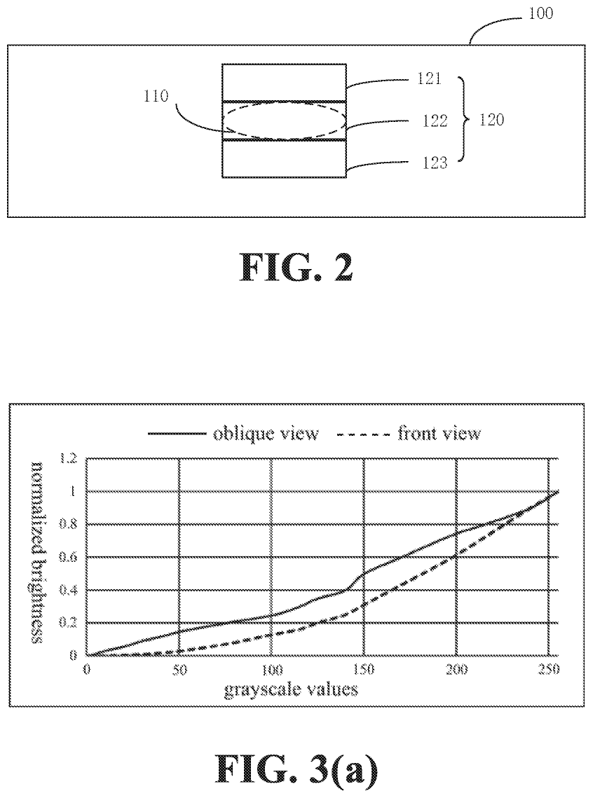

For a clearer description, for a simple example, as shown in FIG. 2, a bright line 110 occurs on a display panel 100, which divides a display area into three parts, namely a first fracture region 121, a second fracture region 122, and to third fracture region 123. Locations of the first fracture region 121, the second fracture region 122, and the third fracture region 123 in the display panel 100 are a fracture location 120.

In some embodiments, after the obtaining the fracture location of the display panel, the method further comprises: detecting grayscale values of sub-pixels in each of the fracture regions to obtain the grayscale value of each of the fracture regions. A grayscale value of each of the fracture regions may be obtained by a detection unit such as Matlab or PhotoShop, but is not limited thereto. Taking Matlab as an example, select fracture regions to be detected, Matlab is used to open images of the fracture regions to be detected, and detect grayscale values of sub-pixels of pixels at a target to obtain grayscale values of the pixels in the fracture regions to be detected. For specific steps, please refer to the prior art, which will not be described in detail herein.

Step 102: performing brightness processing on the fracture regions according to grayscale values of the fracture regions.

The brightness processing refers to using a brightness processing unit to adjust brightness of the fracture regions according to a brightness difference between the fracture regions. The brightness processing unit may be a white balance processing unit, and may also be another unit capable of adjusting brightness in the prior art, which is not limited herein. The brightness processing may be performed by white balance processing. The white balance processing refers to using the white balance processing unit to adjust the brightness of the fracture regions according to the brightness difference between the fracture regions. Specifically, the white balance processing unit may be a logic board (timing controller chip, TCON board).

By inputting original grayscale values of the pixels of the fracture regions to the white balance processing unit, amounts or ratios of the red sub-pixels (R), the green sub-pixels (G) and the blue sub-pixels (B) of the pixels are adjusted, so that new grayscale values, i.e. output grayscale values, of the pixels are obtained. The output grayscale values correspond to new brightness values. Therefore, a purpose of increasing or decreasing the brightness of the fracture regions is achieved. After the brightness of the fracture regions is increased or decreased, it is determined whether the fracture phenomenon at the fracture location is eliminated.

In some embodiments, the performing the brightness processing on the fracture regions according to the grayscale values of the fracture regions comprises:

(1) determining the brightness difference between the fracture regions according to the grayscale values of the fracture regions; and

(2) increasing or decreasing brightness of the fracture regions according to the brightness difference between the fracture regions.

Step 103: determining that there is a brightness difference between the fracture regions before the brightness processing if a brightness difference between the fracture regions is reduced after the brightness processing.

After the fracture location of the display panel is processed by the brightness processing unit, if it is determined that the fracture phenomenon at the fracture location is eliminated, and the brightness difference between the fracture regions is less than that before the processing, it is inferred that there is a difference between brightness of fracture regions before the brightness processing unit processes. The brightness difference between fracture regions may refer to a brightness difference between adjacent fracture regions or between non-adjacent fracture regions. “There is a difference between brightness” refers to “there is a brightness difference between the fracture regions”. The brightness difference causes bright lines to occur on the display panel.

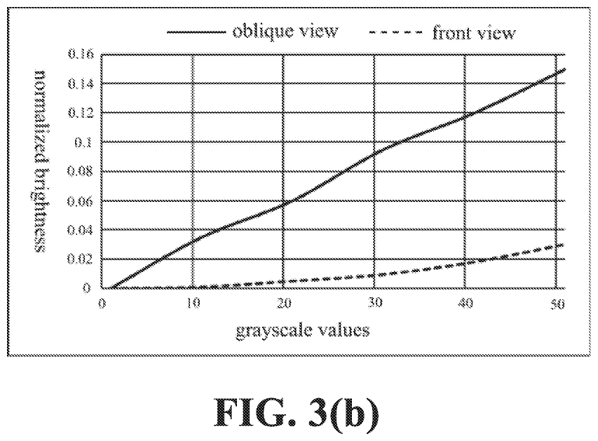

Furthermore, it is easier to perceive the fracture phenomenon on the display panel in oblique view. FIG. 3(a) is a graph showing normalized brightness values at every grayscale level in the display panel actually measured in front view and 45° oblique view (gamma curves of every grayscale level). FIG. 3(b) is a graph showing normalized brightness values at low grayscale level in the display panel actually measured in front view and 45° oblique view (gamma curves of low grayscale level). The abscissa represents grayscale values. The ordinate represents a ratio of a brightness values corresponding to each of the grayscale values to a brightness value corresponding to the highest grayscale value 255 (also called normalized brightness). As an illustrative example, the low grayscale level may comprise grayscale values 0 to 50, a middle grayscale level may comprise grayscale values 50 to 200, and a high grayscale level may comprise grayscale values 201 to 255. However, specific boundary points of low grayscale level, middle grayscale level, and high grayscale level are not limited herein, which may be determined according to specific circumstances. As shown in FIG. 3(a) and FIG. 3(b), a slope of the gamma curve of the low grayscale level in oblique view is greater than a slope of the gamma curve of the low grayscale level in front view, that is, the normalized brightness increases at a greater rate, so that a brightness difference caused by a same grayscale difference is greater. Therefore, at the low grayscale level, it is easier to perceive the brightness difference in oblique view, that is, it is easier to detect the fracture phenomenon of the display image. This also proves that the brightness difference between the fracture regions will cause the fracture phenomenon to occur in the display panel.

In some embodiments, the determining that there is a brightness difference between the fracture regions before the brightness processing if a brightness difference between the fracture regions is reduced after the brightness processing:

(1) determining whether the fracture phenomenon in the fracture regions is eliminated by increasing or reducing the brightness of the fracture regions; and

(2) judging whether the brightness difference between the fracture regions is reduced based on whether the fracture phenomenon in the fracture regions is eliminated.

By performing the brightness processing on the fracture regions, the brightness of the fracture regions is adjusted to change the brightness difference between the fracture regions. Then, it is judged whether the fracture phenomenon is eliminated. If the fracture phenomenon is eliminated, it is judged whether the brightness difference between the fracture regions is decreased. If the fracture phenomenon is eliminated and the brightness difference between the fracture regions is decreased, it is determined that there is a difference between the brightness of the fracture regions. When the brightness difference between the fracture regions is too great, brightness uniformity of the display image is poor, resulting in bright lines.

Step 104: adjusting the brightness of the fracture regions according to the grayscale values of the fracture regions to reduce the brightness difference between the fracture regions if there is a brightness difference between the fracture regions.

If it is determined that a fracture phenomenon between the fracture regions is caused by the brightness difference between the fracture regions, the brightness of the fracture regions is adjusted according to the grayscale values of the fracture regions. The corresponding fracture region may be one, two, or all of the fracture regions, which is not limited herein.

In some embodiments, the adjusting the brightness of the fracture regions according to the grayscale values of the fracture regions to reduce the brightness difference between the fracture regions comprises:

reducing the brightness difference between the fracture regions according to a difference between the grayscale values of the fracture regions.

In this embodiment, a logic board (timing controller chip, TCON board) is used to adjust the brightness of the fracture regions. Based on the grayscale values of the pixels in the fracture regions, brightness values of the fracture regions are increased or decreased to reduce the brightness difference between the fracture regions and eliminate bright lines in display images. The unit for adjusting the brightness of the fracture regions may also be an electronic board (system on a chip, SOC board) and the like, which is not limited herein.

In some embodiments, after the adjusting the brightness of the fracture regions according to the grayscale values of the fracture regions to reduce the brightness difference between the fracture regions, the method further comprises:

dividing the maximum brightness difference value between two adjacent fracture regions after adjusting the brightness by the maximum brightness difference value between the two adjacent fracture regions before adjusting the brightness to obtain a ratio; and

determining that the fracture phenomenon is eliminated if the ratio is less than or equal to 50%.

Display images at different grayscale values have different requirements for brightness uniformity, so degrees of reductions of brightness differences are also different. Experiments show that when the maximum brightness difference value between two adjacent fracture regions after adjusting is less than or equal to 50% of the maximum brightness difference value between the two adjacent fracture regions before adjusting, the fracture phenomenon of the display panel is eliminated. Taking the first fracture region 121 and the second fracture region 122 of FIG. 2 as an example, before adjusting the brightness, a brightness difference between the first fracture region 121 and the second fracture region 122 is a first difference value. After adjusting the brightness, the brightness difference between the first fracture region 121 and the second fracture region 122 is a second difference value. When a ratio of the second difference value to the first difference value is less than or equal to 50%, a fracture phenomenon on the first fracture region 121 and the second fracture region 122 is eliminated.

The present invention improves display brightness uniformity of a display panel, a fracture phenomenon of the liquid crystal display panel, and display quality by obtaining a fracture location of the display panel, performing brightness processing, such as white balance processing, on fracture regions comprised in the fracture location according to grayscale values, determining that there is a brightness difference between the fracture regions if the fracture phenomenon is eliminated after the white balance processing, that is, if the brightness difference between the fracture regions is less than that before the processing, and adjusting the brightness of the fracture location to reduce the brightness difference between the fracture regions.

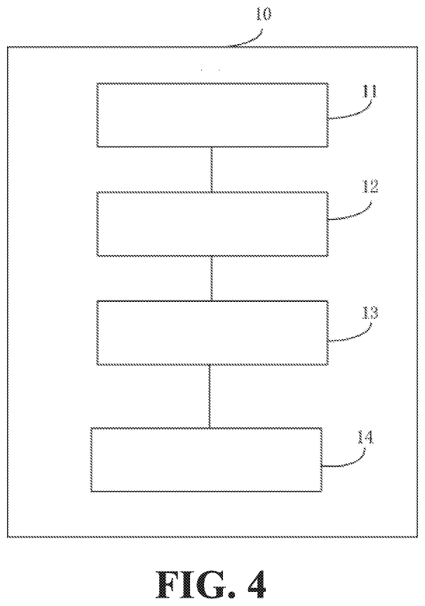

Based on the same inventive concept, in a second aspect, the present disclosure further provides a device 10 for relieving a fracture phenomenon of a liquid crystal display panel. FIG. 4 is a block diagram of the device 10. As shown in FIG. 4, the device 10 comprises an obtaining unit 11, a processing unit 12, a determining unit 13, and an adjusting unit 14.

The obtaining unit 11 is configured to obtain a fracture location of the display panel, wherein the fracture location comprises two or more fracture regions.

The processing unit 12 is configured to perform brightness processing on the fracture regions according to grayscale values of the fracture regions.

The determining unit 13 is configured to determine that there is a brightness difference between the fracture regions before the brightness processing if a brightness difference between the fracture regions is reduced after the brightness processing.

The adjusting unit 14 is configured to adjust the brightness of the fracture regions according to the grayscale values of the fracture regions to reduce the brightness difference between the fracture regions if there is a brightness difference between the fracture regions.

In some embodiments, the device 10 further comprises a detection unit configured to detect grayscale values of sub-pixels in each of the fracture regions to obtain the grayscale value of each of the fracture regions.

In some embodiments, the processing unit 12 comprises:

a first determining subunit configured to determine the brightness difference between the fracture regions according to the grayscale values of the fracture regions; and

a first adjusting subunit configured to increase or decrease brightness of the fracture regions according to the brightness difference between the fracture regions.

In some embodiments, the determining unit 13 comprises:

a second determining subunit configured to determine whether the fracture phenomenon in the fracture regions is eliminated by increasing or reducing the brightness of the fracture regions; and

a first judgment subunit configured to judge whether the brightness difference between the fracture regions is reduced based on whether the fracture phenomenon in the fracture regions is eliminated.

In some embodiments, the adjusting unit 14 comprises:

an obtaining subunit configured to obtain a difference between the grayscale values of the fracture regions; and

a second adjusting subunit configured to reduce the brightness difference between the fracture regions according to the difference between the grayscale values of the fracture regions.

In some embodiments, the adjusting unit 14 further comprises:

a second judgment subunit configured to divide the maximum brightness difference value between two adjacent fracture regions after adjusting the brightness by the maximum brightness difference value between the two adjacent fracture regions before adjusting the brightness to obtain a ratio, and judge whether the ratio is less than or equal to 50%; and

a third determining subunit configured to determine that the fracture phenomenon is eliminated if the ratio is less than or equal to 50%.

The present disclosure provides a device for relieving a fracture phenomenon of a liquid crystal display panel, which comprises: an obtaining unit configured to obtain a fracture location of the display panel; a processing unit configured to perform brightness processing on the fracture regions according to grayscale values of the fracture regions; a determining unit configured to determine that there is a brightness difference between the fracture regions before the brightness processing if a brightness difference between the fracture regions is reduced after the brightness processing; and an adjusting unit configured to adjust the brightness of the fracture regions according to the grayscale values of the fracture regions to reduce the brightness difference between the fracture regions if there is a brightness difference between the fracture regions. The device eliminates the fracture phenomenon of the display panel, makes brightness of the display panel uniform, and improves display effect of the display panel.

In a third aspect, the present disclosure further provides a liquid crystal display panel. The liquid crystal display panel uses the aforementioned method for relieving the fracture phenomenon.

A method and device for relieving a fracture phenomenon of a liquid crystal display panel, and a display panel that are provided by the embodiments of the present disclosure are described in detail above. The present disclosure uses specific examples to describe principles and embodiments of the present application. The above description of the embodiments is only for helping to understand the technical solutions of the present disclosure and its core ideas. It should be understood by those skilled in the art that they can modify the technical solutions recited in the foregoing embodiments, or replace some of technical features in the foregoing embodiments with equivalents. These modifications or replacements do not cause essence of corresponding technical solutions to depart from the scope of the technical solutions of the embodiments of the present disclosure.

In the claims:

1. A method for relieving a fracture phenomenon of a liquid crystal display panel, comprising:
obtaining a fracture location of the display panel, wherein the fracture location comprises two or more fracture regions;
performing brightness processing on the fracture regions according to grayscale values of the fracture regions;
determining that there is a brightness difference between the fracture regions before the brightness processing if the brightness difference between the fracture regions is reduced after the brightness processing; and
adjusting brightness of the fracture regions according to the grayscale values of the fracture regions to reduce the brightness difference between the fracture regions if there is the brightness difference between the fracture regions.

2. The method for relieving the fracture phenomenon of the liquid crystal display panel according to claim 1, wherein after the obtaining the fracture location of the display panel, further comprising:
detecting grayscale values of sub-pixels in each of the fracture regions to obtain the grayscale value of each of the fracture regions.

3. The method for relieving the fracture phenomenon of the liquid crystal display panel according to claim 2, wherein the performing the brightness processing on the fracture regions according to the grayscale values of the fracture regions comprises:
determining the brightness difference between the fracture regions according to the grayscale values of the fracture regions; and
increasing or decreasing the brightness of the fracture regions according to the brightness difference between the fracture regions.

4. The method for relieving the fracture phenomenon of the liquid crystal display panel according to claim 3, wherein the determining that there is the brightness difference between the fracture regions before the brightness processing if the brightness difference between the fracture regions is reduced after the brightness processing comprises:
determining whether the fracture phenomenon in the fracture regions is eliminated by increasing or reducing the brightness of the fracture regions; and
judging whether the brightness difference between the fracture regions is reduced based on whether the fracture phenomenon in the fracture regions is eliminated.

5. The method for relieving the fracture phenomenon of the liquid crystal display panel according to claim 1, wherein the adjusting the brightness of the fracture regions according to the grayscale values of the fracture regions to reduce the brightness difference between the fracture regions comprises:
obtaining a difference between the grayscale values of the fracture regions; and
reducing the brightness difference between the fracture regions according to the difference between the grayscale values of the fracture regions.

6. The method for relieving the fracture phenomenon of the liquid crystal display panel according to claim 1, wherein after the adjusting the brightness of the fracture regions according to the grayscale values of the fracture regions to reduce the brightness difference between the fracture regions, further comprising:
dividing a maximum brightness difference value between two adjacent fracture regions after adjusting the brightness by the maximum brightness difference value between the two adjacent fracture regions before adjusting the brightness to obtain a ratio; and
determining that the fracture phenomenon is eliminated if the ratio is less than or equal to 50%.

7. The method for relieving the fracture phenomenon of the liquid crystal display panel according to claim 1, wherein the brightness processing is performed by white balance processing.

8. A device for relieving a fracture phenomenon of a liquid crystal display panel, comprising:
an obtaining unit configured to obtain a fracture location of the display panel, wherein the fracture location comprises two or more fracture regions;
a processing unit configured to perform brightness processing on the fracture regions according to grayscale values of the fracture regions;
a determining unit configured to determine that there is a brightness difference between the fracture regions before the brightness processing if the brightness difference between the fracture regions is reduced after the brightness processing; and
an adjusting unit configured to adjust brightness of the fracture regions according to the grayscale values of the fracture regions to reduce the brightness difference between the fracture regions if there is the brightness difference between the fracture region.

9. The device for relieving the fracture phenomenon of the liquid crystal display panel according to claim 8, further comprising:
a detection unit configured to detect grayscale values of sub-pixels in each of the fracture regions to obtain the grayscale value of each of the fracture regions.

10. The device for relieving the fracture phenomenon of the liquid crystal display panel according to claim 9, wherein the processing unit comprises:
a first determining subunit configured to determine the brightness difference between the fracture regions according to the grayscale values of the fracture regions; and
a first adjusting subunit configured to increase or decrease the brightness of the fracture regions according to the brightness difference between the fracture regions.

11. The device for relieving the fracture phenomenon of the liquid crystal display panel according to claim 10, wherein the determining unit comprises:
a second determining subunit configured to determine whether the fracture phenomenon in the fracture regions is eliminated by increasing or reducing the brightness of the fracture regions; and
a first judgment subunit configured to judge whether the brightness difference between the fracture regions is reduced based on whether the fracture phenomenon in the fracture regions is eliminated.

12. The device for relieving the fracture phenomenon of the liquid crystal display panel according to claim 8, wherein the adjusting unit comprises:
an obtaining subunit configured to obtain a difference between the grayscale values of the fracture regions; and
a second adjusting subunit configured to reduce the brightness difference between the fracture regions according to the difference between the grayscale values of the fracture regions.

13. The device for relieving the fracture phenomenon of the liquid crystal display panel according to claim 8, wherein the adjusting unit further comprises:
a second judgment subunit configured to divide a maximum brightness difference value between two adjacent fracture regions after adjusting the brightness by the maximum brightness difference value between the two adjacent fracture regions before adjusting the brightness to obtain a ratio, and judge whether the ratio is less than or equal to 50%; and
a third determining subunit configured to determine that the fracture phenomenon is eliminated if the ratio is less than or equal to 50%.

14. A liquid crystal display panel using a method for relieving a fracture phenomenon of the liquid crystal display panel, wherein the method comprises:
obtaining a fracture location of the display panel, wherein the fracture location comprises two or more fracture regions;
performing brightness processing on the fracture regions according to grayscale values of the fracture regions;
determining that there is a brightness difference between the fracture regions before the brightness processing if the brightness difference between the fracture regions is reduced after the brightness processing; and
adjusting brightness of the fracture regions according to the grayscale values of the fracture regions to reduce the brightness difference between the fracture regions if there is the brightness difference between the fracture regions.

15. The liquid crystal display panel according to claim 14, wherein after the obtaining the fracture location of the display panel, the method further comprises:
detecting grayscale values of sub-pixels in each of the fracture regions to obtain the grayscale value of each of the fracture regions.

16. The liquid crystal display panel according to claim 15, wherein the performing the brightness processing on the fracture regions according to the grayscale values of the fracture regions comprises:
determining the brightness difference between the fracture regions according to the grayscale values of the fracture regions; and
increasing or decreasing the brightness of the fracture regions according to the brightness difference between the fracture regions.

17. The liquid crystal display panel according to claim 16, wherein the determining that there is the brightness difference between the fracture regions before the brightness processing if the brightness difference between the fracture regions is reduced after the brightness processing comprises:
determining whether the fracture phenomenon in the fracture regions is eliminated by increasing or reducing the brightness of the fracture regions; and
determining whether the brightness difference between the fracture regions is reduced based on whether the fracture phenomenon in the fracture regions is eliminated.

18. The liquid crystal display panel according to claim 14, wherein the adjusting the brightness of the fracture regions according to the grayscale values of the fracture regions to reduce the brightness difference between the fracture regions comprises:
obtaining a difference between the grayscale values of the fracture regions; and
reducing the brightness difference between the fracture regions according to the difference between the grayscale values of the fracture regions.

19. The liquid crystal display panel according to claim 14, wherein after the adjusting the brightness of the fracture regions according to the grayscale values of the fracture regions to reduce the brightness difference between the fracture regions, the method further comprises:
dividing a maximum brightness difference value between two adjacent fracture regions after adjusting the brightness by the maximum brightness difference value between the two adjacent fracture regions before adjusting the brightness to obtain a ratio; and
determining that the fracture phenomenon is eliminated if the ratio is less than or equal to 50%.

20. The liquid crystal display panel according to claim 14, wherein the brightness processing is performed by white balance processing.
